(19) United States
(12) Patent Application Publication
(10) Pub. No.: US 2004/0143836 A1
(43) Pub. Date: Jul. 22, 2004

(54) System and method for sharing objects among two or more electronic devices

(76) Inventors: Jonathan Ian McCormack, Charlotte, NC (US); Jean-Francois Merlet, Santa Cruz, CA (US); Marco Boerries, Los Altos Hills, CA (US)

Correspondence Address: JONES DAY, 222 EAST 41ST ST, NEW YORK, NY, 10017, US

(21) Appl. No.: 10/348,640

(22) Filed: Jan. 21, 2003

(51) Int. Cl. G06F 9/44

(52) U.S. Cl. 719/316

(57) ABSTRACT

The present invention relates generally to electronic devices with corresponding device DNA and specifically to such electronic devices that share objects by reference to this device DNA. The present invention includes sharing objects among two or more electronic devices with differing object processing capabilities. In particular, a plurality of descriptions of each of the two or more electronic devices and object meta-data, which describes objects, is referenced when objects are exchanged by the two or more electronic devices. For example, if a given electronic device requests an object that it can not process, the object may be transcoded so that this electronic device can process the object. The transcoding is a function of the electronic device's description, the object's object meta-data, and the intended use of the object.

### RELATED APPLICATIONS

This application is related to, and incorporates herein by reference, “SYSTEM AND METHOD FOR MANAGING TWO OR MORE ELECTRONIC DEVICES,” filed on Mar. 11, 2002, attorney docket number 11114-003-888; “SYSTEM AND METHOD FOR ADAPTING PREFERENCES BASED ON DEVICE LOCATION AND NETWORK TOPOLOGY,” filed on Mar. 11, 2002, attorney docket number 11114-004-888; “SYSTEM AND METHOD FOR DELIVERING DATA IN A NETWORK,” filed on Mar. 11, 2002, attorney docket number 11114-005-888; and “SYSTEM FOR STANDARDIZING UPDATES OF DATA ON A PLURALITY OF ELECTRONIC DEVICES,” filed on Mar. 11, 2002, attorney docket number 11114-006-888.

### FIELD OF THE INVENTION

The present invention relates generally to electronic devices with corresponding device DNA and specifically to such electronic devices that share objects by reference to this device DNA.

### BACKGROUND

Conventional peer-to-peer networks rely on each peer having enough information about other peers in the network to communicate with them. In most cases, a peer does not enquire about the capabilities of the other peer before transferring data—it just sends data with the assumption that the other peer will be able to process the data properly. While not without problems, this has been successful in the PC space (peer-to-peer networks comprising two or more personal computers). However, as the computing world becomes less PC centric, this approach may no longer be viable.

In other words, today's peer-to-peer networks may be based on a series of false assumptions. The main failing is an equality principle—that in peer-to-peer networks all devices are equally capable, and all data is used in similar ways. As peer-to-peer networks become less PC centric and include devices such as media players, PDAs, cell phones, and other types of task specific devices, this equality principle will become less reliable.

Even in today's PC centric world the equality principle is not always accurate. Take, for example, a simple peer-to-peer network that exists between two PCs. The first PC (PC1) is a 2 GHZ Pentium with 512 MB of RAM and the latest copy of a video software. The other PC (PC2) is a 600 MHZ notebook PC with 256 MB of RAM and an older version of the same video software. PC1 contains a 100 MB video file that is encoded at full screen resolution and at 29.7 frames per second using the latest video encoder of the video software. If this file is downloaded to PC2, a user may find that the file cannot be played because PC2 does not have enough memory or processor power to play the video and/or because the older version of the video software cannot decode the file.

### SUMMARY OF THE INVENTION

The present invention includes a method of sharing objects among two or more electronic devices with differing object processing capabilities. The method includes: maintaining a plurality of descriptions, wherein the plurality of descriptions includes a separate description for each of the two or more electronic devices; providing access to object meta-data, the object meta-data describing the objects, each of the objects maintained on a respective electronic device from the two or more electronic devices; and triggering a transcoding of an object maintained on a first electronic device from the two or more electronic devices by reference to the object meta-data and by reference to a description of a second electronic device from the two or more electronic devices upon a request to transfer the object to the second electronic device, the second electronic device subsequently able to execute a processing of the object.

The present invention also includes a computer program product for use in conjunction with a computer system. The computer program product comprises a computer readable storage medium and a computer program mechanism embedded therein. The computer program mechanism comprises instructions that maintain a plurality of descriptions, wherein the plurality of descriptions includes a separate description for each of two or more electronic devices in the computer system; instructions that provide access to object meta-data, the object meta-data describing the objects, each of the objects maintained on a respective electronic device from the two or more electronic devices; and instructions that trigger a transcoding of an object maintained on a first electronic device from the two or more electronic devices by reference to the object meta-data and by reference to a description of a second electronic device from the two or more electronic devices upon a request for the object from the second electronic device, the second electronic device subsequently able to execute a processing of the object.

The present invention further includes a computer system for sharing objects among two or more electronic devices with different capabilities for processing objects. The computer system comprises a memory to store instructions and object meta-data and a processor to execute the instructions stored in the memory. The memory stores instructions that maintain a plurality of descriptions, wherein the plurality of descriptions includes a separate description for each of the two or more electronic devices; instructions that provide access to object meta-data, the object meta-data describing the objects, each of the objects maintained on a respective electronic device from the two or more electronic devices; and instructions that trigger a transcoding of an object maintained on a first electronic device from the two or more electronic devices by reference to the object meta-data and by reference to a description of a second electronic device from the two or more electronic devices upon a request for the object from the second electronic device, the second electronic device subsequently able to execute a processing of the object.

### BRIEF DESCRIPTION OF THE DRAWINGS

Additional objects and features of the invention will be more readily apparent from the following detailed description and appended claims when taken in conjunction with the drawings, in which:

FIG. 1 illustrates a system of electronic devices in accordance with an embodiment of the present invention.

FIG. 2 illustrates an electronic device that is consistent with an embodiment of the present invention.

FIG. 3 illustrates an intermediate server that is consistent with an embodiment of the present invention.

FIG. 4 illustrates exemplary processing steps for object sharing by electronic devices via an object briefcase.

FIG. 5 also illustrates exemplary processing steps for object sharing by electronic devices via an object briefcase.

Like reference numerals refer to the same element throughout the several views of the drawings.

### DESCRIPTION OF THE PREFERRED EMBODIMENTS

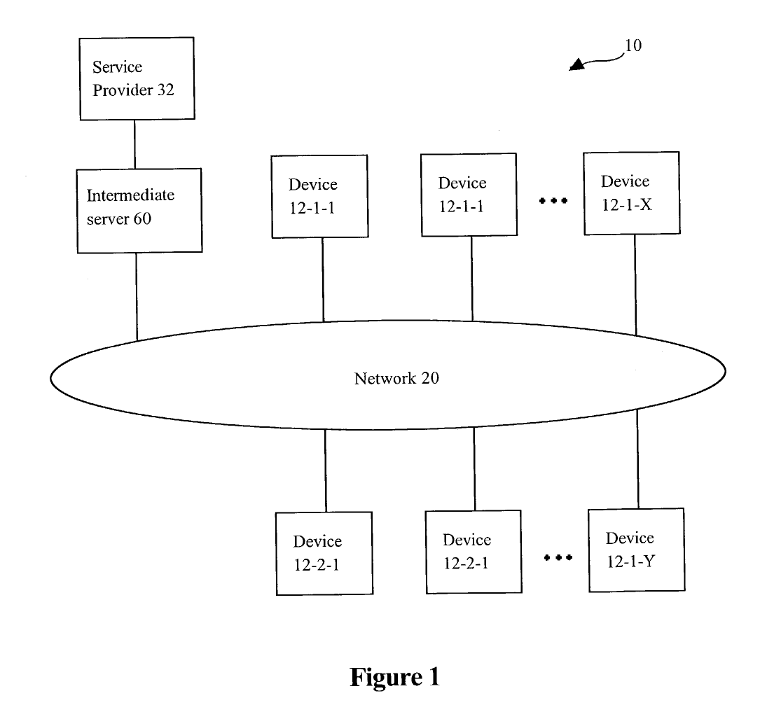

Referring to FIG. 1, there is shown a system 10 that is operated in accordance with one embodiment of the invention. System 10 includes a network 20, one or more electronic devices 12, an intermediate server 60, and a service provider 32. As illustrated in FIG. 1, each of the electronic devices 12 and the intermediate server 60 are connected to the network 20. The connection between the intermediate server 60 may be a wireline connection (e.g., a connection comprising metallic wire conductors and/or optical fibers). The electronic devices 12 are not typified by any particular type of connection. The electronic devices 12 may be connected to the network 20 by a wireline connection and/or a wireless connection (e.g., a connection comprising electromagnetic waves such as RF, infrared, laser, visible light, and acoustic energy).

The precise technique used by the electronic devices 12 and the intermediate server 60 to establish a physical connection to the network 20, and thus each other 12, 60 is not critical to the present invention.

Service provider 32 is an electronic service such as an Internet service provider. Representative service providers 32 include, but are not limited to, Deutsche Telekom (Bonn Germany), Yahoo! (Sunnyvale, Calif.), AT&T Broadband (Denver, Colo.), Microsoft Network (Redmond, Wash.), Sprint (Kansas City, Mo.), FedEx Corporation (Memphis, Tenn.), and OnStar. A service provider 32 can provide access to services such as stock tracking programs, address programs, and accounting programs, through the electronic devices 12—as described in more detail below. A service provider 32 can also provide access to services such as Microsoft Exchange Server (Redmond, Wash.), Internet Message Access Protocol (IMAP) server, and the Lightweight Directory Access Protocol (LDAP) Server. LDAP is designed to run directly over a TCP/IP stack. An IMAP server provides a method of accessing electronic mail or bulletin board messages that are kept on a mail server that may or may not be shared.

Although the network topology shown in FIG. 1 illustrates a service provider 32 that is external to the intermediate server 60, the invention is not limited to this network topology. In some embodiments of the present invention, the server provider 32 is a software module that is hosted by the intermediate server 60.

In embodiments in which a service provider 32 is not hosted by the intermediate server 60, the service provider 32 and the intermediate server 60 are connected by a communications network. In some embodiments, the communications network is a local area network (LAN), wide area network (WAN), metropolitan area network (MAN), an Intranet, the Internet, or any combination of such networks.

As described in more detail below, a service provider 32 and an electronic device 12 communicate through the intermediate server 60. Generally, communication of data between computers and other types of devices within a first network (e.g., network 20) and between computers and other types of devices in another network (e.g., the communications network connecting a service provider 32 and the intermediate server 60) is handled by a hierarchy of protocols each of which simplifies a stage in the communication process (see, for example, Computer Networks, A Systems Approach, Peterson, L. L. and Davie, B. S., Morgan Kaufmann, Inc., 1996, incorporated herein by reference).

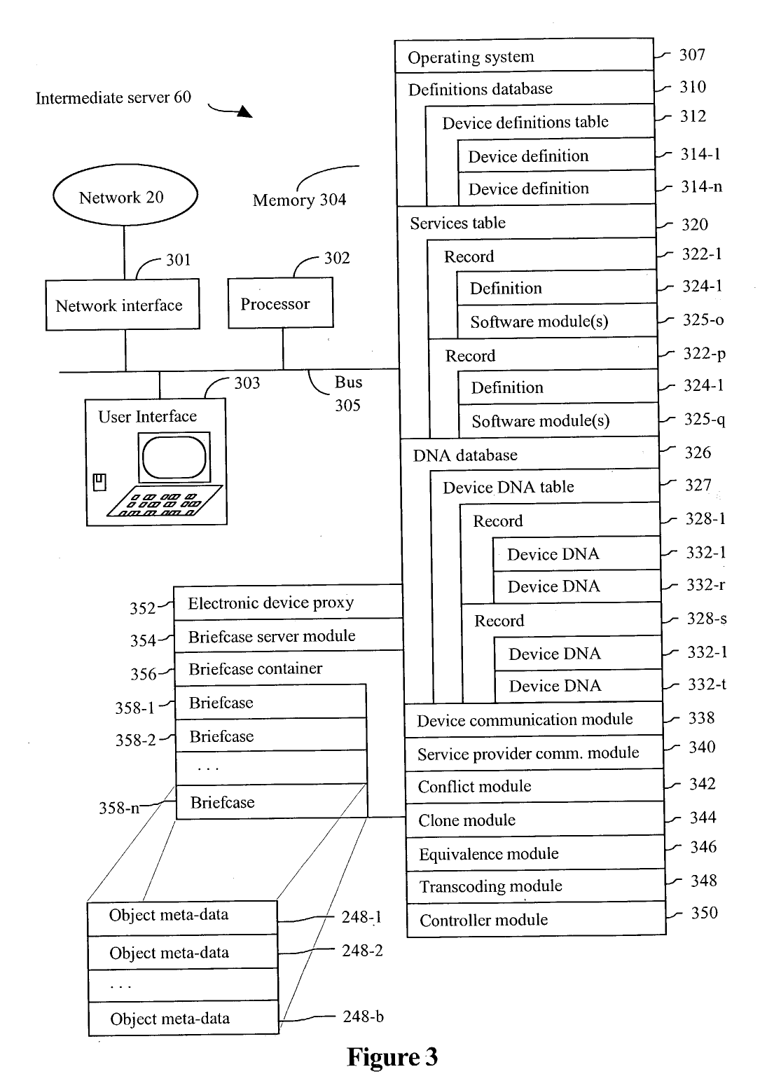

The service provider 32 typically creates an account for each user (e.g., corporate entity or individual) who uses the services provided by the service provider 32. The account typically specifies information such as usernames and passwords, authorized users, and service subscriptions (e.g., a given account may provide access to only a subset of the services provided by a given service provider 32). An account preferably specifies one or more electronic devices 12 that may be used in conjunction with the account. For example, a given account may indicate that a PDA and a cell phone (two types of electronic devices 12) may be used to access services provided by the service provider 32 (through the intermediate server 60). The account preferably includes, therefore, information that can be used to identify and/or contact an electronic device 12 (e.g., a telephone number of a cell phone) corresponding to the account. Additionally, the service provider 32 preferably provides a means for modifying the account. For example, a web based interface may be provided to enable a user to add, remove, or modify one or more services and electronic devices 12 corresponding to the account. Additionally, an electronic device 12 may be configured to access only a subset of services otherwise available to or through a corresponding account. As described in more detail below, this account information is passed on to the intermediate server 60, which incorporates this information into a device DNA table 327 (FIG. 3).

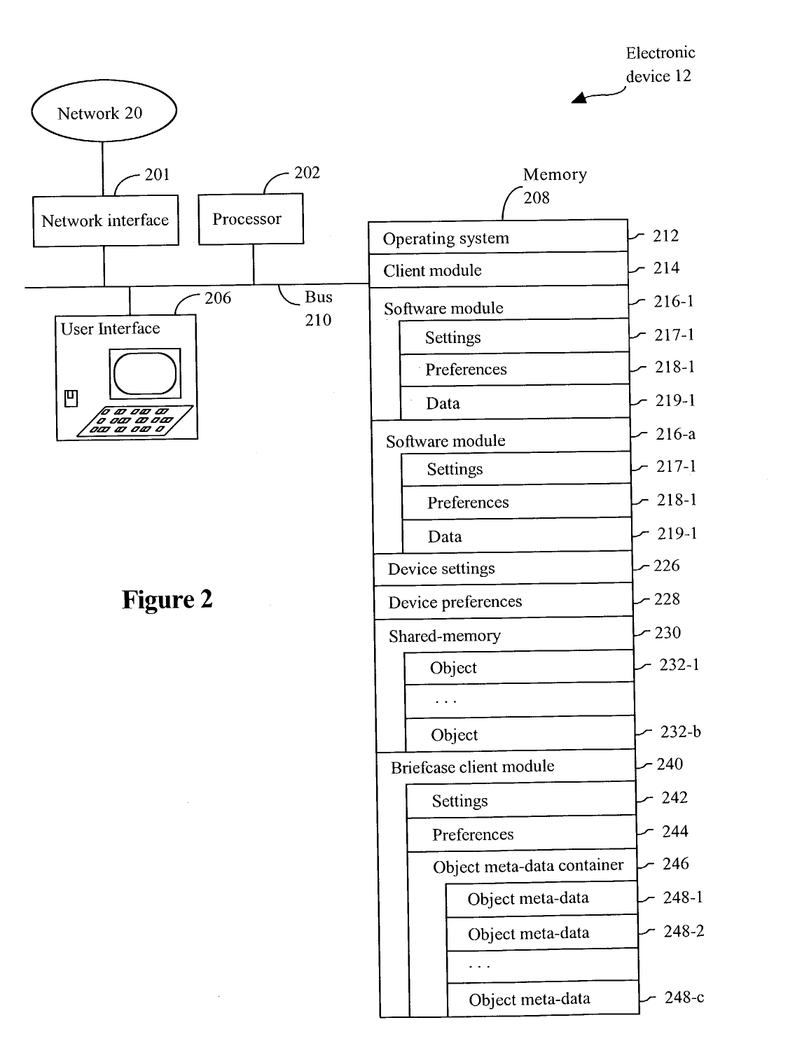

As noted above, the present invention includes a system and method in which users are able to share, publish, backup, replicate, etc. objects (e.g., audio files, video files, image files, document files, application data, URLs, etc.) among two or more electronic devices 12. In preferred embodiments, this is accomplished with object meta-data 248 (FIG. 2 and FIG. 3), which describes a plurality of objects 242 (FIG. 2) accessible to one or more users, that is accessible to the users via one or more electronic devices 12. As described in detail below, each electronic device 12 may act as a master source that stores an object 232. A user accesses the object meta-data 248, which is preferably stored at a central location (e.g., at the intermediate server 80) and transmitted (in whole or in part) to electronic devices 12 as it is updated. If a user wishes to access an object 232 stored on a remote electronic device 12 and described in object meta-data 248 stored on the user's electronic device 12, the object 232 is transferred to the user's electronic device 12 (temporarily or permanently) from the remote electronic device 12. As described in more detail below, the present invention makes use of device DNA 332 (FIG. 3) and object descriptions to ensure that when processed by a given electronic device 12, an object is in a format accessible by the electronic device 12.

As illustrated in FIG. 2, an electronic device 12 typically includes the following components: a network interface 201, a processor 202, a user interface 206, a memory 208, and a bus 210, which interconnects the aforementioned components. The network interface 201 couples the electronic device 12 to the network 20. The precise structure of this component is governed by how the electronic device 12 communicates with the network 20 (e.g., wireless or wireline). The processor 202 executes various software modules maintained in the memory 208 as described in more detail below. The user interface 206 enables a user to interact with the electronic device 12 and typically includes components such as a keyboard, touch pad screen/display, microphone, and speakers.

The memory 208, which typically includes high speed random access memory as well as non-volatile storage such as disk storage, stores an operating system 212, a client module 214, one or more software modules 216, device settings 226, device preferences 228, a shared-memory 230, which may store one or more objects 232, a briefcase client module 240, briefcase settings 242, briefcase preferences 244, and an object meta-data container 246, which contains object meta-data 248.

The operating system 212 includes procedures for handling various basic system services and for performing hardware dependent tasks. The operating system 212 also provides software modules 214, 216 with access to system resources, such as the memory 208 and the user interface 206.

The client module 214 enables the intermediate server 60 to manage the configuration of the electronic device 12. The client module 214 can receive and process data from the intermediate server 60. For example, the intermediate server 60 may transmit a software module and an instruction to install the software module over the network 20 to the electronic device 12. The client module 214, in communication with the intermediate server 60, may then receive and initiate installation of the software module. The client module 214 also preferably has access to the shared-memory 230, device preferences 228, device settings 226, and software modules 216, including the settings 217, preferences 218, and data 219 of the software modules 216. Accordingly, the client module 214 is typically capable of modifying, adding, or deleting all or some aspect of each. The client module 214 may also transmit some or all of the device preferences 228, device settings 226, and software modules 216, including the settings 217, preferences 218, and data 219 of the software modules 216 to the intermediate server 60 and/or a service provider 32. The client module 214, moreover, may also transmit information about items including the device preferences 228, device settings 226, and software modules 216, including the settings 217, preferences 218, and data 219 of the software modules 216, without actually transmitting these items. For example, the client module 214 may only indicate that a change has been made to an aspect of a corresponding electronic device 12.

The client module 214 preferably communicates with the intermediate server 60 using an efficient protocol. In particular, the protocol preferably operates effectively over both wireless and wireline networks, is adaptable to the capabilities of each type of electronic device 12 described herein, and supports a wide variety of transport protocols. In some embodiments of the present invention, the client module 214 comprises a SyncML stack.

The software modules 216 include all manner of software modules installed on electronic devices 12. An exemplary software module 12 is a e-mail program. E-mail programs in general include settings 217, preferences 218, and data 219. Settings 217 and preferences 218 are similar concepts and include, for example, limitations on the size of a corresponding address book and interface preferences. As indicated above, the data 219 may comprise an address book or other information.

The device settings 226 may control how the electronic device 12 interacts with the network 20. Each of the software modules 216, therefore, access the network 20 in a manner defined by the device settings 226. Similarly, the device preferences 228 may preselect certain options when such options are presented to the electronic device 12. For example, when a software module 216 is being installed, it may default to a particular language as defined by the device preferences 228.

The shared-memory 230 may be used by the software modules 216, operating system 212, and/or the client module 214 to store data (e.g., objects 232) independently or under the direction of a user.

As described in more detail below, a briefcase 358 (FIG. 3) is preferably an association of object meta-data 248. The term “briefcase” does not limit the present invention and is used only as a convenient name. Each electronic device 12 in a set of corresponding electronic devices 12 (i.e., a set of electronic devices 12 registered by a user to access a given briefcase) has access to the briefcase 358 (e.g., the object meta-data stored therein). From this briefcase 358, the electronic devices 12/users are able to access the objects 232 described by the object meta-data. Some electronic devices 12 in the set of corresponding electronic devices may be a write-only device (e.g., a web page or web publishing hardware/software) that makes objects 232 accessible on the Internet (e.g., the object 232 is downloadable from a web page). Such electronic devices 12 may receive objects 232 corresponding to object meta-data 248 maintained in a briefcase 358, but do not typically interact with the briefcase 358 otherwise.

Referring again to FIG. 2, the briefcase client module 240 enables the intermediate server 60 to provide access to briefcases 358 (FIG. 3), communicate with other electronic devices 12 in a peer-to-peer manner, and communicate with still other electronic devices 12 via the electronic device proxy 352 (FIG. 3). Accordingly, the briefcase client module 240 can receive and process data from the intermediate server 60. Typically, the intermediate server 60 may transmit over the network 20 object meta-data 248 with an instruction for the briefcase client module 240 to store the object meta-data 248 in the object meta-data container 246 of a given electronic device 12. The briefcase client module 240 also preferably has access to the shared-memory 230, briefcase preferences 244, briefcase settings 242, and, as indicated above, the object meta-data container 246. Accordingly, the briefcase client module 240 is typically capable of modifying, adding, or deleting all or some aspect of each. The briefcase client module 240 may also transmit some or all of the object meta-data 248 to the intermediate server 60 as needed.

As described in more detail below, object meta-data 248 may be updated locally, and then transmitted to the intermediate server 60, which then forwards the updated object meta-data 248 to other electronic devices 12 corresponding to the electronic device 12 that is the source of the updated object meta-data 248. More specifically, the client module 214 may transmit object meta-data 248 without transmitting the objects 232 that correspond to the updated object meta-data 248. For example, if the objects 232 that correspond to the updated object meta-data 248 were not transferred from another electronic device 12, they may not be transmitted without a specific request from another electronic device 12 or unless the object 232 are replicated/backed up by another device (e.g., an electronic device 12 or the intermediate server 60).

Further, the briefcase client module 240 enables users of an electronic device 12 to view the object meta-data 248 maintained in the object meta-data container (and in a briefcase 358, FIG. 3) as, for example, a disk/drive (such as a CD-RW disk or network drive). Accordingly, the briefcase client module 240 preferably enables users to add and remove objects 232 to and from categories (which may be represented by folders on electronic devices 12 with robust processing power and displays such as personal computers) represented in a view of the briefcase 358. For example, the briefcase client module 240 preferably enables users to add objects 232 to categories within the briefcase 358 that are designated as backup categories (e.g., a category in which all objects are automatically backed up on one or more other devices such as the intermediate server 60 and/or other electronic devices 12). Preferably, an object may be placed in one or more categories.

And, depending on the briefcase settings 242 and preferences 244, which are described in more detail below, the briefcase client module 240 transmits changes of views (e.g., the inclusion of another object 232 or a sort order of the member objects 232) to corresponding electronic devices 12 (e.g., some or all of other electronic devices with access to a given briefcase 358) so similar changes are made to views of the briefcase 358 from these electronic devices 12. Finally, the briefcase client module 240 preferably enables users of the electronic devices 12 to engage in peer management (e.g., management of corresponding electronic devices 12) and object management.

In some embodiments, the electronic devices 12 communicate directly only to transfer objects 232. For example, if a user, through a first electronic device 12, requests an object 232, which is maintained by or stored on a second electronic device 12, corresponding to object meta-data maintained on the first electronic device 12 (and preferably the second electronic device 12), the second electronic device 12 may transfer the object 232 to the first electronic device 12 through a path that does not include the intermediate server 60. In preferred embodiments, this occurs if the object 232 being transferred is not transcoded prior to arriving at the first electronic device 12. For example, if the first electronic device 12 is unable to process the object 232 (e.g., edit or view the object 232), the second electronic device 12 may transfer the object to the intermediate server 60, which transcodes the object 232 and then forwards the object 232 to the first electronic device 12 (this process is described in more detail below).

Like the client module 214, the briefcase client module 240 preferably communicates with the intermediate server 60 using an efficient protocol. In particular, the protocol preferably operates effectively over both wireless and wireline networks, is adaptable to the capabilities of each type of electronic device 12 described herein, and supports a wide variety of transport protocols. For example, the briefcase client module 240 may comprise a SyncML stack such that the protocol is SyncML, HTTP, and/or peer-to-peer (e.g., JXTA or JABBER). Persons skilled in the art recognize that peer-to-peer protocols, such as JXTA and JABBER, comprise a set of protocols that allow electronic devices 12 (e.g., cell phones, wireless PDAs, and PCs) and the intermediate server 60 (e.g., PC) to communicate and collaborate in a peer-to-peer fashion. More specifically, peer-to-peer devices (e.g., electronic devices 12) create a virtual network where devices interact directly even though some of the devices are behind firewalls/network address translators or communicating on different network transports. Further, the briefcase client module 240 may be a win32 native application (e.g., an executable that depends only on the Microsoft C-runtime library) and/or web-based fat clients (e.g., Internet browsers, wireless application protocol browsers, or voice user applications).

The briefcase settings 242 may define, for example, views of the object meta-data container 246/briefcase 358 as seen by a user of the electronic device 12. Views may include a view by object category, object source (e.g., electronic devices 12 that are the source of a given object 232), or by services available for objects 232. Moreover, the briefcase settings 242 and/or the briefcase preferences 244 may define or at least influence how objects 232 are transferred to and from the intermediate server 60 and/or other electronic devices 12. For example, these briefcase settings 242 and/or the briefcase preferences 244 may specify that a given electronic device 12 has a relatively slow network connection to the intermediate server 60 and/or other electronic devices 12. As a result, requests for objects 232 stored by other electronic devices 12 may reflect this limitation and, thereby, affect the transcoding of the requested object 232 (e.g., cause the intermediate server 60 to reduce the resolution of an image). In some embodiments, however, these particular settings and preferences are incorporated within a given device's device DNA 332.

Additionally, the briefcase settings 242 and/or the briefcase preferences 244 may specify default intended uses for a given type of object 232. For example, they may specify that images (e.g., types of objects 232) are displayed as thumbnails by default. As a result, images may be transcoded so that their resolution is reduced prior to being transmitted to a corresponding electronic device 12. As indicated above, such settings and/or preferences would be incorporated into requests for such objects 232 as an intended use.

In preferred embodiments, a user may optionally specify uses for objects 232 when requesting objects 232. For example, if a user intends to edit an image, it may be sent with full resolution to the electronic device 12 executing the request. But if the user intends to view the image as a thumbnail, it may be sent with reduced resolution to the electronic device 12 executing the request. These intended uses are preferably incorporated into requests for such objects 232 as an intended use. Further, the briefcase settings 242 and/or the briefcase preferences 244 may specify that some or all objects 232 (e.g., specific objects 232 or specific types of objects) be replicated on, published to, synchronized, aggregated, or otherwise transported to one or more other electronic devices 12 each time these objects 232 are updated and/or created.

As indicated above, the object meta-data 248 describes corresponding objects 232. The object meta-data 248 preferably includes a creation date, a last-edit date, owner (e.g., a source such as an electronic device 12 of the object 232), object size, object type, default object handling instructions, Multipurpose Internet Mail Extensions, etc. When objects 232 are created on a given electronic device 12, data such as default object handling instructions from the briefcase settings 242 and/or the briefcase preferences 244 may be incorporated into the corresponding object meta-data, which is preferably distributed to the intermediate server 60 and corresponding electronic devices 12.

As illustrated in FIG. 3, the intermediate server 60 includes standard server components including a network interface 301 for coupling intermediate server 60 to other devices via network 20, a processor 302 for executing various software modules maintained in a memory 304, an optional user interface 303 (e.g., keyboard, mouse, and display), the memory 304, and a bus 305 for interconnecting the aforementioned components.

The memory 304, which typically includes high speed random access memory as well as non-volatile storage such as disk storage, stores a number of software modules and data structures that are used in accordance with the present invention. In a typical embodiment, the memory 304 includes an operating system 307, which generally comprises procedures for handling various basic system services and for performing hardware dependent tasks, a definitions database 310, a services table 320, a DNA database 326, a device communication module 338, a service provider communication module 340, a conflict module 342, a clone module 344, an equivalence module 346, a transcoding module 348, a controller module 350, an electronic device proxy 352, a briefcase server module 354, and a briefcase container 356, which stores one or more briefcases 358. The briefcases 358 object meta-data 248 for one or more objects 232.

The definitions database 310 preferably includes at least a device definitions table 312, which describes electronic devices 12 in detail. More specifically, the device definitions table 312 comprises a record 314 for each of the types of electronic devices 12 with which the intermediate server 60 may communicate. The records 314 preferably include fixed hardware descriptions, removable hardware descriptions, and operating system (and/or other required software module) descriptions for these electronic devices 12. The records 314 also preferably include information such as typical device configurations, supported software modules, feature sets, and hardware limitations. For example, if a particular type of an electronic device 12 (e.g., a hand held computer) only has black and white displays, this fact is included in a corresponding device definition 314. As described in more detail below, each record 314 includes information that enables the creation of device DNA for a corresponding electronic device 12. The device definitions table 312 is preferably updated as new electronic devices 12 become available.

The services table 320 comprises a plurality of records 322 for each service offered by a service provider 32. Each of the plurality of records 322 preferably include a sub-record 324 with a definition of (e.g., information about) a corresponding service and a sub-record 325 with one or more software modules used in conjunction with the corresponding service. The definition sub-record 324 preferably includes, but is not limited to, a description of the service, a list of services or software modules with which the service conflicts, authentication requirements for using the service, device hardware requirements of the service, and software module requirements of the service. Memory usage and processor speed requirements, for example, may be included in the definition. The software module(s) sub-record 325 includes each software module that may be required by a corresponding service. In other words, the software module(s) sub-record 325 includes software modules such as e-mail programs, games, dynamic link libraries, and virtual machines and software modules such as patches and/or upgrades that modify other software modules. The services table 320 is preferably created and/or updated as information (e.g., definitions and software modules) becomes available.

The DNA database 326 includes one or more tables storing DNA. In particular, the DNA database 326 includes a device DNA table 327, which stores device DNA for each electronic device 12 that may interact with the intermediate server 60. More specifically, the device DNA table 327 includes a record 328 for each account created by the service provider 32 and forwarded to the intermediate server 60 as described above. Each of these records 328 includes a sub-record 332 for each electronic device 12 corresponding to the account. Included in a sub-record 332 is device DNA for a corresponding electronic device 12. For example, device DNA for a given electronic device 12 typically includes: a fixed hardware description, a removable hardware description (including whether a given removable hardware component was ever attached), a list of software modules installed on the electronic device 12, software module settings and preferences, a description of the data for each of the software modules (but preferably not the data itself), data source settings, a list of users who can use the electronic device 12, the device specific configuration for each service available through the electronic device 12 (e.g., the location of an e-mail server), and device specific mappings of data sources (e.g., which address book entries are stored on which device for a specific user). Descriptions of the data typically identify when the data was last changed, periods in which the data did not change, how many entries are included in the data (in the case of a list or database), the size of the data, and/or a general description of the data. The sub-record, moreover, may include any corresponding information found in the definitions database 310 and the services table 320. There is a one to one correspondence between each electronic device 12 in the system 10 and corresponding device DNA maintained in a record 332.

As described in detail below, device DNA may be uploaded to the intermediate server 60 from electronic devices 12 in order to update a corresponding device DNA entry 332. Additionally, an update of the device DNA may be triggered by the service provider 32 when, for example, a user adds or removes a service accessible through one or more electronic devices 12 corresponding to the user's account. The device DNA of a given account may also be modified in a manner that corresponds to changes made to another device DNA corresponding to a common account.

As noted above, the data itself is preferably not included in the device DNA. Instead, the data is maintained and/or backed-up, if at all, by the service provider 32. So when the intermediate server 60 copies data from one electronic device 12 to another (as described in detail below), the data is typically obtained from a service provider 32. Nevertheless, device DNA may include settings and/or preferences from a corresponding electronic device 12. As a result, an electronic device 12 may obtain settings and/or preferences directly from device DNA of another electronic device 12 instead of, or in addition to, the intermediate server 60.

Again, the service provider 32 typically provides a defined number of services. Additionally, an electronic device 12 may include software modules and data unrelated to the services provided by a service provider 32. In preferred embodiments of the present invention, information pertaining to such software modules and data is not included in the device DNA. Instead, such information is preferably excluded entirely from the device DNA or included only to the extent that it affects software modules, data, etc., corresponding to a service provided by a service provider 32. For example, if the services table 320 indicates that a first software module (e.g., a software module not included in the services table 320) conflicts with a second software module (e.g., a software module included in the services table 320), the device DNA may reflect that the first software module is installed on a corresponding electronic device 12 to avoid conflicts.

The service provider communication module 340 communicates with a service provider 32. The protocol that the service provider communication module 340 uses to communicate with a service provider 32 depends upon the exact specifications of the service provider 32. Typically, however, the service provider communication module 340 employs one or more open web standards known in the art to communicate with a service provider 32.

The device communication module 338 communicates with electronic devices 12. Device communication module 338 works in conjunction with the controller module 350 (described below) and the device DNA table 327 in order to accomplish this task. More specifically, the device communication module 338 uses the information in the device DNA table 327 to customize communication with a respective electronic device 12. For example, the device communication module 338 uses the information in the device DNA table 327 to select a protocol that is most efficient given the characteristics of the respective electronic device 12.

The conflict module 342 is designed to avoid conflicts concerning software modules that are, or may be, installed on an electronic device 12. As indicated above, the services table 320 defines software modules needed to provide a particular service and defines dependencies and conflicts between services, between services and software modules, and between services and hardware components (e.g., the size of memory 208). Using this information, in conjunction with device DNA, the conflict module 342 determines whether a software module to be installed on an electronic device 12 will operate successfully. If not, the conflict module 342 modifies the device DNA such that this software module is not installed until the conflict module 342 determines that the software module will operate successfully. A change in such a determination usually results from software and/or hardware changes on the corresponding electronic device 12 (e.g., a conflicting software module is removed and/or memory 208 is expanded).

The clone module 344 is designed to make services (e.g., data, preferences, settings, software modules) available on an old electronic device 12 available on a new electronic device 12. More specifically, the clone module 344 migrates the device DNA of the old electronic device 12 into a new device DNA entry 332 (typically corresponding to the same account record 328). As described in more detail below, the next time the new electronic device 12 connects to the intermediate server 60, any software modules, settings, preferences, and/or data defined by the new device DNA entry 332 are downloaded to the new electronic device 12 (in what may be termed a bootstrap process). Note that the device DNA is not typically an exact copy since information such as device identification usually must be unique; but the services provided by corresponding electronic devices 12 usually are identical. The clone module 344 is typically employed when a user upgrades to a new electronic device 12, when a user acquires a second electronic device 12, and when an existing electronic device 12 is lost and replaced.

The equivalence module 346 is designed to identify a means for providing equivalent access to services that are not otherwise available. Typically, a service provider 32 provides services that can only be accessed by specific software modules installed on an electronic device 12. More specifically, a first software module may be used by a first electronic device 12 to provide access to a service; whereas a second software module may be used by a second electronic device 12 to provide access to the same service. This is usually the result of differences between the first electronic device 12 and the second electronic device 12 (e.g., hardware differences and/or software differences). For example, e-mail service on a cell phone and a PDA (two types of electronic devices 12) may be provided by different software modules and include different feature sets, but access the same e-mail account. In other words, the access to the e-mail account is not equivalent on the respective electronic devices 12. Another example is a word processing software module operating on a relatively robust electronic device 12. Less robust electronic devices 12 (e.g., electronic devices 12 with less memory 208) may not be able to run the same word processing software module. Instead, the less robust electronic device 12 may operate a less demanding word processing software module—with a correspondingly limited set of features. In other words, the two electronic devices 12 do not provide the same access to an idealized word processing software module.

The equivalence module 346 is typically engaged when a first electronic device 12 is modified to provide access to a service provided by the service provider 32. The equivalence module 346 identifies software modules needed to provide equivalent access to the service on one or more other corresponding electronic devices 12 (e.g., electronic devices 12 corresponding to a common account). The equivalence module 346 then uses these identifications to modify the device DNA corresponding to the one or more other corresponding electronic devices 12. As described in more detail below, the next time the one or more other corresponding electronic devices 12 connect to the intermediate server 60, any software modules, settings, preferences, and/or data defined by the modified device DNA entry are downloaded to the one or more other corresponding electronic devices 12. The one or more other corresponding electronic devices 12 may then be capable of providing the same or equivalent access to the service.

The transcoding module 348 is designed to provide a plurality of views of data to match the capabilities of different electronic devices 12. For example, on an electronic device 12 with limited memory 208, only contacts of a contact list that have been accessed within a predefined period of time are transmitted to and stored by the electronic device 12. In this situation, the transcoding module 348 filters contact information sent to this electronic device 12. More specifically, control information is stored in the device DNA of an electronic device 12. The control information defines the view of information required by a corresponding electronic device 12. Each time this electronic device 12 accesses a particular service, the control information (e.g., the device DNA) is used by the transcoding module 348 to identify data items from a data source stored by a corresponding electronic device and the format of the data items. For example, a particular data item may comprise three fields on a first electronic device 12, but one field on a second electronic device 12. The transcoding module 348 detects this fact and takes appropriate steps to transform the data as it is transmitted back and forth between the electronic devices 12 and between electronic devices 12.

To clarify, take the example of two electronic devices 12 operating different word processing software modules cited above with respect to the equivalence module 346. Because one word processing software module may not be able to process, for example, certain style sheets supported by the other word processing software module, the transcoding module 348 may allow transmission of a document created on the robust electronic device 12 only after the document has been saved to a version supported by the word processing software module running on the less robust electronic device 12. In other words, the transcoding module controls the view of the document by reference to device DNA and object meta-data that describes the document (e.g., object 232).

Other examples of transcoding include a resolution reduction of an image file, re-sampling of an audio file at a lower rate, and re-sampling of a video file at a lower rate in order to reduce the size of the corresponding file. The transcoding module 348 may take such action if, for example, a request from an electronic device 12 indicates that the user intends only to display the requested object on an electronic device with limited audio, video, and/or network bandwidth capabilities.

The controller module 350 typically orchestrates the activities of the various modules described above. The controller module 350 also executes tasks not allocated to any of the various modules described above.

The electronic device proxy 352 performs some or all of the tasks usually performed by the briefcase client module 240 for electronic devices 12 unable to install and run the briefcase client module 240. The intermediate server 60 may, therefore, store briefcase settings 242, briefcase preferences 244, and the object container 246 (not illustrated in FIG. 3) for each such electronic device 12. The electronic device proxy 352 may communicate with the device communication module 338 to interact with the client module 214 of an electronic device 12. In embodiments of the invention in which the electronic device proxy 352, the briefcase server module 354 and corresponding components are maintained on a computer system separate from the intermediate server 60, the electronic device proxy 352 may use the Simple Object Access Protocol (“SOAP”)/Enterprise Java Beans (“EJB”) to communicate with the controller module 350, which in turn directs the device communication module 338 to communicate with electronic devices 12.

The briefcase server module 354 manages the briefcase container 356, which is described below, and interacts with briefcase client modules 240 (albeit indirectly). More specifically, the briefcase server module 354 interacts with the briefcase container 356 in order to, for example, store briefcase 358 data (e.g., updated object meta-data 248) received from electronic devices 12, forward such data to other electronic devices with corresponding object meta-data 248, and facilitate transfers of objects from one electronic device 12 to another. Other tasks involving the briefcase server module 354 and the briefcase container 356 are described in more detail below.

As indicated above, the briefcase container 356 manages and stores briefcases 358 on behalf of electronic devices 12 and/or users. The briefcase container 356 may also manage account data such as ownership of briefcases 358, account access by users other than owners (e.g., buddies, administrators, etc.), and briefcase 358 preferences (e.g., method of updating briefcases 358 such as polling electronic devices 12 for updated object meta-data 248).

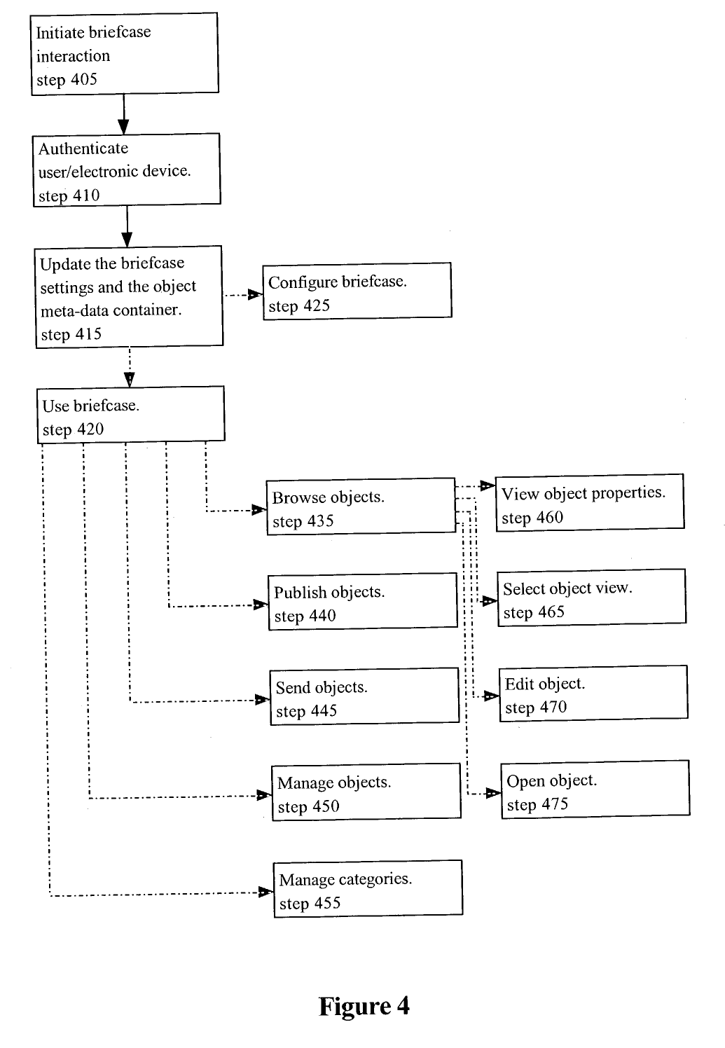

FIG. 4 illustrates a series of processing steps of a typical electronic device 12. In a first step, the briefcase interaction is initiated (step 405). This step may comprise, for example, a user launching the briefcase client module 240 or an electronic device 12 being powered on, which triggers the launching of the briefcase client module 240. In the first step, the briefcase client module 240 may make contact with the intermediate server 60 (e.g., the briefcase server module 354) to authentic the user/electronic device 12 (step 410). For example, the briefcase client module 240 may prompt the user for a username and password combination that is subsequently transmitted to the briefcase server module 354 for authentication. The briefcase client module 240 may also access a username and password combination maintained in the briefcase settings 242 that is subsequently transmitted to the briefcase server module 354 for authentication.

If the user/electronic device 12 is authenticated by the briefcase server module 354, the briefcase client module 240 updates the briefcase settings 242 and the object meta-data container 246 (step 415). The result of this step is that updated object meta-data and applicable briefcase settings maintained by the intermediate server 60 may be requested and transmitted to the electronic device 12. As indicated above, the object meta-data container 246 stores object meta-data 248 corresponding to objects 232 maintained on one or more corresponding electronic devices 12. If objects 232 are modified, deleted, and/or created, these activities are reflected in object meta-data 248. As such, updated object meta-data 248 is requested in case such activity has taken place since the briefcase client module 240 was last active or running. The briefcase client module 240 may also transmit updated object meta-data 248 corresponding to objects 232 maintained locally by the electronic device 12 to the intermediate server 80. Such data is subsequently transmitted to corresponding electronic devices 12 by the intermediate server 80. After the briefcase client module 240 updates the briefcase settings 242 and the object meta-data container 246, a user may use the briefcase (step 420) or configure the briefcase (step 425).

Configuring a briefcase (step 425) may include creating a briefcase (e.g., a second briefcase associated with the user/account or the electronic device 12 in use), deleting a briefcase (e.g., a second briefcase associated with the user/account or the electronic device 12 in use), setting global preferences (e.g., preferences maintained in the briefcase preferences 244 of some or all of the corresponding electronic devices 12), setting local preferences (e.g., preferences maintained only in the local briefcase preferences 244 or that otherwise affect only a given electronic device 12 such as local application preferences, local file system preferences, or local peer-to-peer preferences), managing ‘buddies’ (e.g., other users with limited access to a given briefcase 358), and managing another electronic device 12. Setting global preferences may include setting synchronization configurations (e.g., setting the synchronization parameters for corresponding electronic devices 12 for some or all objects 232 based on synchronization filters, associating synchronization filters to electronic devices 12, scheduling synchronizations, etc.), setting notification parameters based on notification filters (e.g., setting the notification services and specifying for each notification some additional parameters like aggregation of the notification, black-out periods, scheduling, etc.), setting content filters to protect the content of the briefcase 358 and/or specific electronic devices 12 from this content. Managing buddies may include adding buddies, deleting buddies, and managing access rights of buddies.

As indicated in FIG. 4, using a briefcase 358 may include browsing objects (step 435), publishing objects (step 440), sending objects (step 445), managing objects (step 450), and managing categories (step 455).

Browsing objects, moreover, may include viewing object properties (step 460), selecting object views (step 465), editing objects (step 470), and opening objects (step 475). With respect to viewing object properties, a user may interact with the briefcase client module 240 in order to view object properties via object meta-data 248 maintained in the object meta-data container 246 such as an object's 232 creation date, last-edit date, owner, object size, object type, default object handling instructions, Multipurpose Internet Mail Extensions, etc. With respect to selecting object views, a user may specify how object meta-data 248 maintained in the object meta-data container 246 is viewed. For example, the user may specify an arrangement of the object meta-data 248 by reference to which electronic devices 12 maintain corresponding objects 232.

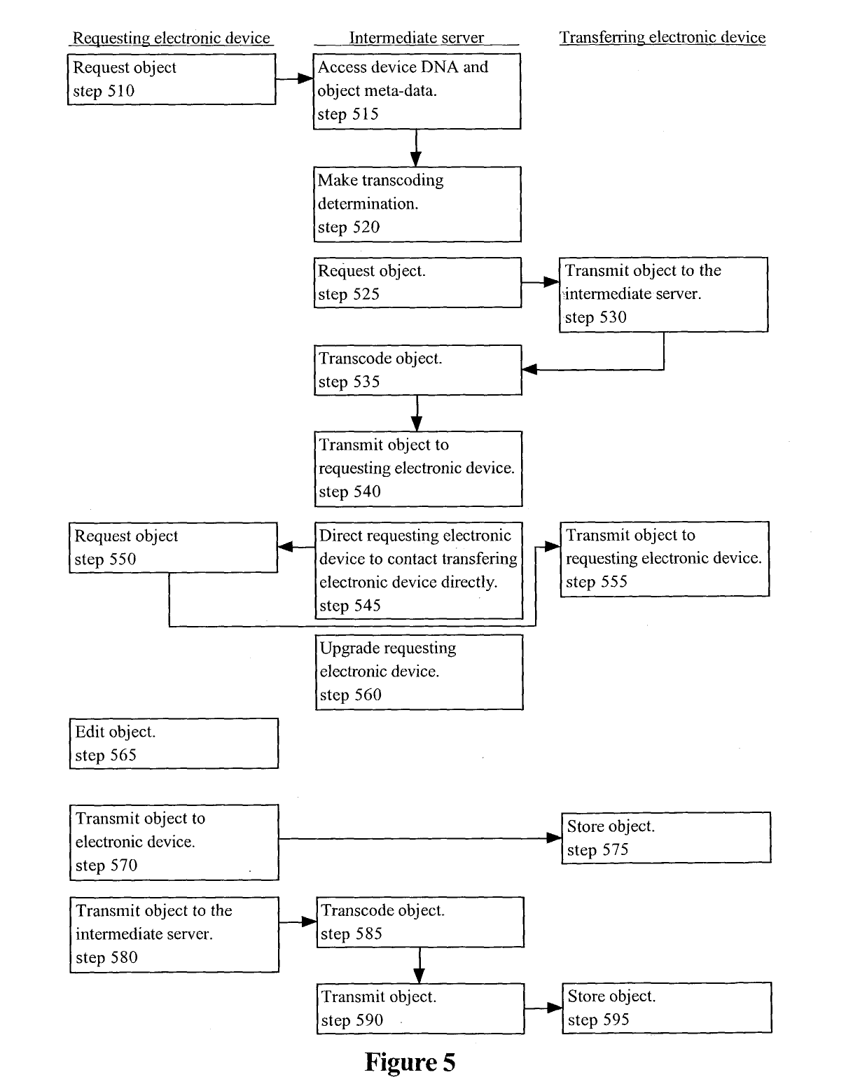

With respect to editing objects, a user may request that an object 232, if not maintained locally, be transferred to a given electronic device 12 so that the user may edit the object 232. When this occurs, a request for the object 232 is preferably sent to the briefcase server module 354 (step 510, FIG. 5), which responds by accessing (via the controller module 350) the given electronic device's 12 device DNA maintained in the device DNA table 327 and the object's object meta-data 248 maintained by the briefcase server module 354 in a briefcase 358 in the briefcase container 356 (step 515). The briefcase server module 354 preferably accesses an intended use of the object in conjunction with the electronic device's 12 device DNA and the object's object meta-data 248. This intended use maybe specified in the request or stored as a defult use in the electronic device's 12 device DNA.

After accessing this data, the briefcase server module 354 determines whether the requested object 232 must be transcoded prior to the object 232 being transferred to the requesting electronic device 12, whether the requesting electronic device 12 must be upgraded, the type or extent of transcoding, or whether the requesting electronic device is capable processing the requested object after the requested object is transcoded and/or the requesting electronic device 12 is upgraded (i.e., makes a transcoding determination) (step 520). For example, the requesting electronic device 12 may be unable to run one or more applications used to create the requested object 232. In such cases, the requesting electronic device 12 may have equivalent applications selected by the equivalence module 346 that nevertheless require that an object 232 be saved to a different format in order to edit the object 232. Additionally, the intended use may specify that the user/electronic device 12 does not intend to modify the object (e.g., view, print, publish, or play back the object) or does intend to modify (e.g., edit) the object 232. The former intended use may not require that, for example, an image (i.e., the requested object 232) be transferred to the requesting electronic device 12 at full resolution. The later intended use may require, however, that the image be transferred to the requesting electronic device 12 at full resolution in order to facilite image modification.

After making the transcoding determination (step 520), the briefcase server module 354 may (via the controller module 350) request the object 232 from the electronic device 12 storing the requested object (i.e., the transferring electronic device) (step 525), which responds by transmitting the requested object 232 to the intermediate server 80 (step 530). Once transferred to the intermediate server 80, the requested object 232 is transcoded by the transcoding module 348 (step 535) and then transmitted to the requesting electronic device 12 (step 540). As described above, the transcoding may be affected by the intended use of the object 232 as well as the object meta-data 248 and other aspects of the requesting electronic device's 12 device DNA 332 (e.g., an indication of limited audio, video, and/or network bandwidth capabilities).

After making the transcoding determination (step 520), the briefcase server module 354 may also direct the requesting electronic device 12 to contact the transferring electronic device 12 directly for the requested object 232 (step 545). The requesting electronic device 12 then transmits a request for the object 232 directly to the transferring electronic device 12 (step 550), which then transfers the requested object 232 to the requesting electronic device 12 (step 555). In some embodiments, the intermediate server 80 may instruct (directly or indirectly) the transferring electronic device 12 to perform some transcoding of the requested object 232 prior to transmitting the object 232 to the requesting electronic device 12. For example, the intermediate server 80 may instruct electronic devices 12 (e.g., the transferring electronic device 12) to perform certain transcoding when specific, or classes of, electronic devices 12 (e.g., the requesting electronic device 12) request objects 232. Alternatively, the intermediate server 80 may instruct the requesting electronic device 12 to include a transcoding instruction with the request for the object 232 sent directly to the transferring electronic device 12.

After making the transcoding determination (step 520), the briefcase server module 354 may, moreover, upgrade the requesting electronic device 12 (step 560). Typically, this includes transferring software to the requesting electronic device 12 and directing the client module 214 to install this software module. An upgrade may also include only an adjustment of the electronic device's 12 settings 226 and preferences 228 or a particular software module's settings 217 and preferences 218. After step 560, the intermediate server 80 may re-execute step 515 and make another transcoding determination or execute steps 525 or 545 as described above on the basis of the initial transcoding determination.

If the object 232 is edited (step 565), the object 232 may be transferred back to the transferring electronic device 12 (step 570), which stores the object 232 (step 575). These steps may be taken if, for example, the requested object 232 was not transcoded prior to transferral to the requesting electronic device 12 or if the requested object 232 is to be stored in the transcoded form.

Alternatively, the object 232 is transferred back to the intermediate server 80 (step 580), which transcodes the object 232 back to the form it was transcoded from in step 535 (step 585) and then transmits the object 232 back to the transferring electronic device 12 (step 590). The transferring electronic device 12 stores the object 232 (step 595).

Additionally, the object meta-data 248 corresponding to the requested object is updated during steps described above and illustrated in FIG. 5. For example, the object meta-data preferably reflects that the requesting electronic device 12 is editing the requested object or that the requested object 232 is in a given form following transcoding. In particular, after receiving the object, the requesting electronic device 12 preferably updates the requested object's object meta-data 248, which is subsequently transmitted back to the intermediate server 80 and then to any other electronic devices 12 with access to the requested object 232, whether or not the object 232 is updated (e.g., identifies itself within the object meta-data 248 as the most recent electronic device 12 to request and view the object 232). In some embodiments, the electronic device 12 does not automatically transmit updated object meta-data to the intermediate server 60. Instead, the intermediate server periodically polls electronic devices 12 for updated object meta-data 248 and requests (and distributes) the same if detected.

With respect to opening objects, a user may request that an object 232, if not maintained locally, be transferred to a given electronic device 12 so that the user may open (e.g., view without modifying) the object 232. This process is similar to that described above with reference to editing objects and illustrated in FIG. 5 with the exception that the object 232 need not be transcoded a second time or otherwise transmitted back to the source of the object 232. Again, opening an object 232 may include viewing or playing back the object.

With respect to publishing objects, a user may request that an object be published on a write-only device such as a web page. This may include, for example, a user adding an object 232 (to be published) to a category or folder of a given briefcase 358 (viewed via the briefcase client module 240 on the electronic device 12). The briefcase client module 240 preferably responds by transmitting a request to publish the object 232 to the briefcase server module 354. The briefcase server module 354 preferably responds by accessing (via the controller module 350) the device DNA of the electronic device 12 that will publish the object 232 and the object's object meta-data 248 maintained by the briefcase server module 354 in a briefcase 358 in the briefcase container 356. After accessing this data, the briefcase server module 354 determines whether the object 232 to be published must be transcoded prior to the object 232 being transferred to the requesting electronic device 12 that will publish the object 232 (typically via the electronic device proxy 352). This may occur if the object 232 is not in a form acceptable, and thus publishable, by the electronic device 12 that will publish the object 232. If so, the briefcase server module 354 may (via the controller module 350) direct the transcoding module 348 to transcode the object 232. This typically includes the object 232 being transferred to the intermediate server, whereupon it is transcoded by the transcoding module 348, and then transmitted to the electronic device 12 that will publish the object 232.

With respect to sending objects, a user may request that an object be transmitted to a remote service (e.g., a service provided by the service provider 32 such as object replication or a web-based picture service) or a local service such as a printer, fax service, CD burner, etc. The briefcase client module 240 preferably responds by transmitting a request to send the object 232 to the briefcase server module 354. The briefcase server module 354 preferably responds by accessing (via the controller module 350) the device DNA of the requesting electronic device 12 and the object's object meta-data 248 maintained by the briefcase server module 354 in a briefcase 358 in the briefcase container 356. After accessing this data, the briefcase server module 354 determines whether the object 232 to be sent must be transcoded prior to the object 232 being sent. This may occur if the object 232 is not in a form acceptable to the service provider 32 or one of the local services. If so, the briefcase server module 354 may (via the controller module 350) direct the transcoding module 348 to transcode the object 232. This typically includes the object 232 being transferred to the intermediate server, whereupon it is transcoded by the transcoding module 348, and then sent the designated service.

With respect to managing objects, this may include a user adding an object 232, deleting an object 232, and updating an object 232 (e.g., updating properties associated with the object instead of the object itself). And with respect to managing categories, a user may create new categories for objects, update existing categories, or move categories (e.g., move a category within an existing category tree). Such actions are preferably propagated to the corresponding briefcase 358 and briefcase client modules 240 of corresponding electronic devices 12.

While the present invention has been described with reference to a few specific embodiments, the description is illustrative of the invention and is not to be construed as limiting the invention. Various modifications may occur to those skilled in the art without departing from the true spirit and scope of the invention as defined by the appended claims.

Alternate embodiments include electronic devices 12 that store the device DNA 332 of all corresponding electronic devices 12. In these embodiments, some or all of the electronic devices 12 exchange objects 232 over a path that does not include the intermediate server 60 whether or not the object 232 is transcoded. These electronic devices 12, therefore, include a type of transcoding module 348 configured to run on the electronic devices 12 such that the intermediate server 60 may not be used to perform this task.

In still other alternate embodiments in which the electronic devices 12 include transcoding modules 348, specific types of objects 232 may be transcoded by electronic devices 12 each time these objects 232 are created or updated. Instructions for doing so may be incorporated within the settings 242 and preferences 244 of electronic devices 12 and triggered each time a type of object 232 is created or updated or received from the intermediate server 80 each time a type of object 232 is created or updated and the corresponding object meta-data 248 is created or updated (and received by the intermediate server 80).

What is claimed is:

1. A method of sharing objects among two or more electronic devices with differing object processing capabilities, comprising maintaining a plurality of descriptions, wherein said plurality of descriptions includes a separate description for each of the two or more electronic devices;
providing access to object meta-data, said object meta-data describing the objects, each of said objects maintained on a respective electronic device from the two or more electronic devices; and
triggering a transcoding of an object maintained on a first electronic device from the two or more electronic devices by reference to the object meta-data and by reference to a description of a second electronic device from said two or more electronic devices upon a request to transfer said object to said second electronic device, said second electronic device subsequently able to execute a processing of said object.

2. The method of claim 1, further comprising
linking the plurality of descriptions, wherein a change to a description included in said plurality of descriptions triggers a separate change to each other description included in said plurality of descriptions; and
synchronizing the separate descriptions to a respective electronic device from the two or more electronic devices, wherein a change to said separate description triggers a corresponding change to said respective electronic device and wherein a change to said respective electronic device triggers a corresponding change to said separate description.

3. The method of claim 1, further comprising
including for each object described in the object meta-data an identification of an electronic device from the two or more electronic devices maintaining, respectively, said each object.

4. The method of claim 1, further comprising copying the object from the first electronic device to the second electronic device upon the request for said object from said second electronic device.

5. The method of claim 4, further comprising
detecting a modification of the object by the second electronic device; and
triggering a second transcoding of the object upon said detecting.

6. The method of claim 5, further comprising copying the object from the second electronic device to the first electronic device following the processing of said object.

7. The method of claim 1, wherein the processing does not include modifying the object.

8. The method of claim 1, wherein the processing does include modifying the object.

9. The method of claim 1, further comprising
triggering a modification of the second electronic device by reference to the object meta-data and by reference to the description of said second electronic device upon the request for the object when the transcoding alone does not render said second electronic device able to execute the processing of said object.

10. The method of claim 9, wherein the modification includes installing a software module on the second electronic device that is compatible with the object.

11. The method of claim 1, further comprising
maintaining a description of a connection between the first electronic device and the second electronic device, wherein the transcoding is made by reference to the description of the connection.

12. The method of claim 1, further comprising
maintaining a first description, said first description describing a connection between the first electronic device and a third device not included in the two or more electronic devices; and
maintaining a second description, said first description describing a connection between the second electronic device and the third device, whereby the transcoding is made by reference to the first and second description.

13. The method of claim 1, wherein
the request includes an intended use of the object, wherein the transcoding is made by reference to said intended use of said object.

14. The method of claim 1, further comprising
triggering an upgrade of the second electronic device by reference to the object meta-data and by reference to the description of said second electronic device upon the request to transfer the object to said second electronic device.

15. A computer program product for use in conjunction with a computer system, the computer program product comprising a computer readable storage medium and a computer program mechanism embedded therein, the computer program mechanism comprising:
instructions that maintain a plurality of descriptions, wherein said plurality of descriptions includes a separate description for each of two or more electronic devices in the computer system;
instructions that provide access to object meta-data, said object meta-data describing the objects, each of said objects maintained on a respective electronic device from the two or more electronic devices; and
instructions that trigger a transcoding of an object maintained on a first electronic device from the two or more electronic devices by reference to the object meta-data and by reference to a description of a second electronic device from said two or more electronic devices upon a request for said object from said second electronic device, said second electronic device subsequently able to execute a processing of said object.

16. The computer program product of claim 15, further comprising
instructions that link the plurality of descriptions, wherein a change to a description included in said plurality of descriptions triggers a separate change to each other description included in said plurality of descriptions; and
instructions that synchronize the separate description to a respective electronic device from the two or more electronic devices, wherein a change to said separate description triggers a corresponding change to said respective electronic device and wherein a change to said respective electronic device triggers a corresponding change to said separate description.

17. The computer program product of claim 15, further comprising
instructions that include for each object described in the object meta-data an identification of an electronic device from the two or more electronic devices maintaining, respectively, said each object.

18. The computer program product of claim 15, further comprising instructions that copy the object from the first electronic device to the second electronic device upon the request for said object from said second electronic device.

19. The computer program product of claim 18, further comprising
instructions that detect a modification of the object by the second electronic device; and
instructions that trigger a second transcoding of the object upon said detecting.

20. The computer program product of claim 19, further comprising instructions that copy the object from the second electronic device to the first electronic device following the processing of said object.

21. The computer program product of claim 15, wherein the processing does not include modifying the object.

22. The computer program product of claim 15, wherein the processing does include modifying the object.

23. The computer program product of claim 15, further comprising
instructions that trigger a modification of the second electronic device by reference to the object meta-data and by reference to the description of said second electronic device upon the request for the object when the transcoding alone does not render said second electronic device able to execute the processing of said object.

24. The computer program product of claim 23, wherein the modification includes installing a software module on the second electronic device that is compatible with the object.

25. The computer program product of claim 15, further comprising
instructions that maintain a description of a connection between the first electronic device and the second electronic device, wherein the transcoding is made by reference to the description of the connection.

26. The computer program product of claim 15, further comprising
instructions that maintain a first description, said first description describing a connection between the first electronic device and a third device not included in the two or more electronic devices; and
instructions that maintain a second description, said first description describing a connection between the second electronic device and the third device, whereby the transcoding is made by reference to the first and second description.

27. The computer program product of claim 15, wherein
the request includes an intended use of the object, wherein the transcoding is made by reference to said intended use of said object.

28. The computer program product of claim 15, further comprising
instructions that trigger an upgrade of the second electronic device by reference to the object meta-data and by reference to the description of said second electronic device upon the request to transfer the object to said second electronic device.

29. A computer system for sharing objects among two or more electronic devices with different capabilities for processing objects comprising:
a memory to store instructions and object meta-data;
a processor to execute the instructions stored in the memory;
the memory storing
instructions that maintain a plurality of descriptions, wherein said plurality of descriptions includes a separate description for each of the two or more electronic devices;
instructions that provide access to object meta-data, said object meta-data describing the objects, each of said objects maintained on a respective electronic device from the two or more electronic devices; and
instructions that trigger a transcoding of an object maintained on a first electronic device from the two or more electronic devices by reference to the object meta-data and by reference to a description of a second electronic device from said two or more electronic devices upon a request for said object from said second electronic device, said second electronic device subsequently able to execute a processing of said object.

30. The computer system of claim 29, further comprising
instructions that link the plurality of descriptions, wherein a change to a description included in said plurality of descriptions triggers a separate change to each other description included in said plurality of descriptions; and
instructions that synchronize the separate description to a respective electronic device from the two or more electronic devices, wherein a change to said separate description triggers a corresponding change to said respective electronic device and wherein a change to said respective electronic device triggers a corresponding change to said separate description.

31. The computer system of claim 29, further comprising
instructions that include for each object described in the object meta-data an identification of an electronic device from the two or more electronic devices maintaining, respectively, said each object.

32. The computer system of claim 29, further comprising instructions that copy the object from the first electronic device to the second electronic device upon the request for said object from said second electronic device.

33. The computer system of claim 32, further comprising
instructions that detect a modification of the object by the second electronic device; and
instructions that trigger a second transcoding of the object upon said detecting.

34. The computer system of claim 33, further comprising instructions that copy the object from the second electronic device to the first electronic device following the processing of said object.

35. The computer system of claim 29, wherein the processing does not include modifying the object.

36. The computer system of claim 29, wherein the processing does include modifying the object.

37. The computer system of claim 29, further comprising
instructions that trigger a modification of the second electronic device by reference to the object meta-data and by reference to the description of said second electronic device upon the request for the object when the transcoding alone does not render said second electronic device able to execute the processing of said object.

38. The computer system of claim 37, wherein the modification includes installing a software module on the second electronic device that is compatible with the object.

39. The computer system of claim 29, further comprising
instructions that maintain a description of a connection between the first electronic device and the second electronic device, wherein the transcoding is made by reference to the description of the connection.

40. The computer system of claim 29, further comprising
instructions that maintain a first description, said first description describing a connection between the first electronic device and a third device not included in the two or more electronic devices; and
instructions that maintain a second description, said first description describing a connection between the second electronic device and the third device, whereby the transcoding is made by reference to the first and second description.

41. The computer system of claim 29, wherein
the request includes an intended use of the object, wherein the transcoding is made by reference to said intended use of said object.

42. The computer system of claim 29, further comprising
instructions that trigger an upgrade of the second electronic device by reference to the object meta-data and by reference to the description of said second electronic device upon the request to transfer the object to said second electronic device.
